(19) United States
(12) Patent Application Publication
(10) Pub. No.: US 2011/0315688 A1
(43) Pub. Date: Dec. 29, 2011

(54) CONTAINER VENT AND METHOD OF VENTING A CONTAINER

(76) Inventor: TIMOTHY CONTARINO, Mooresville, NC (US)

(21) Appl. No.: 12/822,136

(22) Filed: Jun. 23, 2010

(51) Int. Cl. B65D 25/14; B23P 11/00

(52) U.S. Cl. 220/495.04; 29/428

(57) ABSTRACT

A trash can vent comprising a set of end panels, a plurality of air flow panels between the end panels, where the plurality of air flow panels raise and lower in an alternating fashion, and a plurality of cutouts at a bottom portion of the plurality of air flow panels. The trash can vent also comprises a set of adhesive strips against a backside of the set of end panels wherein the adhesive strips attach the trash can vent to an inner wall of a container to allow an air flow to pass along the trash can vent while a trash bag is inside the container. An air freshener is attached to a backside of the plurality of air flow panels. The trash can vent allows for easy and convenient bag removal by eliminating the vacuum created when lifting the trash bag out of the container.

### BACKGROUND OF THE INVENTION

1. Field of the Invention

The present invention relates to a container vent for simple removal of a trash bag from the container and method of venting the container.

2. Description of Related Art

A common annoyance associated with trash bag removal is how to get the bags out of the trash can or similar container. Either the bag rips, the whole can is lifted off the ground or another person must be called in for assistance. Lifting a trash bag may be especially difficult for those who are physically weak or live alone. The problem is created by a vacuum inside the container. The vacuum develops as the bag is filled with trash thus causing the bag expand against the wall of the trash can. In order to remove the bag, the vacuum seal must be broken by allowing air to flow between the bag and the trash can wall. Breaking the vacuum seal is especially difficult when the bag is full which may cause many people to not fill their trash bags. Less full bags means more wasted space thus wasted money on throwing away partially filled bags.

It would be beneficial to have a way to remove a trash bag without the struggle caused by the suction of the bag against the trash can walls. It would also be desirable to have a device which allows air to flow freely between the trash bag and the trash can wall.

### SUMMARY OF THE INVENTION

The present invention enables the easy removal of trash or garbage bags from a container. The present invention relates to a trash can vent which attaches to the inside wall of a trash can. The trash can vent includes a plurality of accordion panels to allow air to flow freely between the trash or garbage bag and the wall of the trash can. The flowing air prevents the vacuum effect and the bag does not adhere to the trash can walls thus allowing for more trash to be added before removal. People will save money by not wasting space in the bag and always throwing away completely full trash bags.

Another object of the present invention is to provide an air freshener on the trash can vent to emit a scent when the trash bags are removed.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 is a perspective view of a trash can vent according to an exemplary embodiment of the present invention;

FIG. 2 is a rear view of a trash can vent according to an exemplary embodiment of the present invention; and

FIG. 3 is a perspective view of a bottom portion of a trash can vent according to an exemplary embodiment of the present invention.

Like reference numerals refer to like parts throughout the description of several views of the drawings.

### DETAILED DESCRIPTION OF THE DRAWINGS

The present invention relates to a trash can vent that allows a user to smoothly remove a garbage or trash bag from a container. The trash can vent may comprise multiple panels that join together in an accordion fashion. The accordion design of the present invention may permit air to flow along the trash can vent, thus easing trash bag lifting and removal. The trash can vent may attach to an inner wall of the container with adhesive strips along the backside the panels. A final feature of the present invention includes an odor eliminating air freshener between the container wall and the trash can vent.

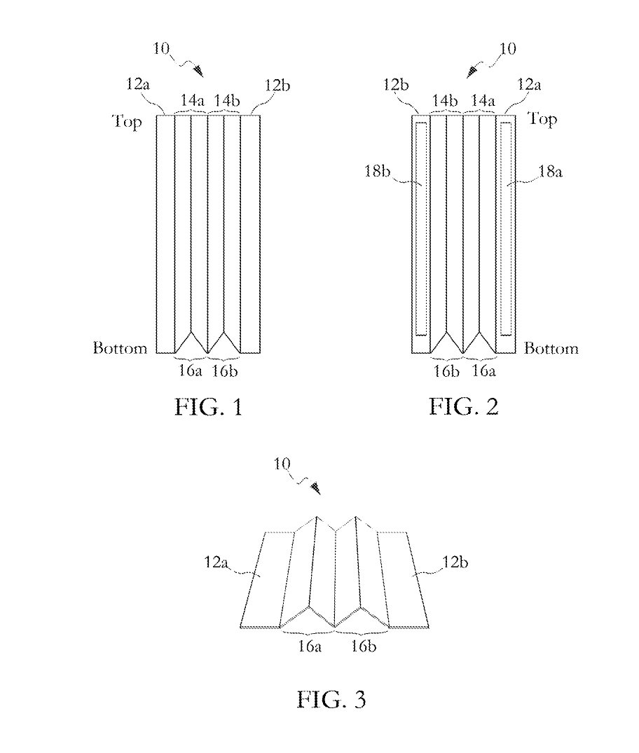

Turning now descriptively to the drawings, referring to FIG. 1, a perspective view of a trash can vent (10) is shown. The trash can vent may have a set of end panels (12a and 12b) (hereinafter end panels) and a set of air flow panels (14a and 14b) (hereinafter air flow panels). The end panels (12a and 12b) and the air flow panels (14a and 14b) may extend the entire length of the trash can vent (10). The end panels (12a and 12b) may be along the sides of the trash can vent (10), and on each side of the air flow panels (14a and 14b). The end panels (12a and 12b) may rest against an inside wall of a container. The container may be a trash can or another type of commonly used receiving receptacle. The air flow panels (14a and 14b) may be angular depressions which raise and lower in an alternating fashion much like an accordion. At a bottom portion of the air flow panels (14a and 14b) may be a cutout (16a and 16b). The cutout (16a and 16b) may be V-shaped or U-shaped. The cutout (16a and 16b) may allow air to pass between the trash can vent (10) and the air flow panels (14a and 14b). The free flow of air along the wall of the container may prevent a suction or vacuum of air when lifting a trash bag.

Referring to FIG. 2, a rear view of a trash can vent (10) is shown in accordance with an exemplary embodiment of the present invention. Along the end panels (12a and 12b) may be a set of adhesive strips (18a and 18b) (hereinafter adhesive strips). The adhesive strips (18a and 18b) may stick or attach the trash can vent (10) to the inner wall of the container. The adhesive strips may be reusable to transfer the trash can vent between various containers.

Referring to FIG. 3, a perspective view of a bottom portion of the trash can vent (10) according to an exemplary embodiment of the present invention is shown. The end panels (12a and 12b) lie flat against the inside wall of the container as seen in FIG. 3. Also, FIG. 3 shows how the cutouts (16a and 16b) create passages to allow air to pass between the trash can vent (10) and container.

The trash can vent (10) may be a light weight apparatus, formed from a hard plastic, a recycled plastic or similar moldable material. The trash can vent (10) may extend the entire length of the container to permit maximum air circulation. An odor eliminating air freshener may be placed on a backside of the air flow panels (14a and 14b). As air flows between the air flow panels (14a and 14b) and the inner trash can wall, a pleasing scent emits from the air freshener. The trash can vent (10) may stop the vacuum or suction created when a trash bag is lifted from a trash can, therefore removal of the trash bag may be easy and convenient. Finally, with less force required to lift the bag, more trash may be added, thus saving money on the number of trash bags a household uses each year.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiments were chosen and described in order to best explain the principles of the invention and its practical application, to thereby enable others skilled in the art to best utilize the invention and various embodiments with various modifications as are suited to the particular use contemplated.

What is claimed is:

1. A container vent for assisting in the removal of a trash bag within the container comprising:
a set of end panels;
a plurality of air flow panels between the end panels;
a plurality of cutouts at a bottom portion of the plurality of air flow panels; and
a set of adhesive strips against one side of the set of end panels wherein the adhesive strips provide a means to attach the trash can vent to an inner wall of the container to allow an air flow to pass through the trash can vent.

2. The trash can vent according to claim 1, wherein the plurality of air flow panels raise and lower in an alternating fashion.

3. The trash can vent according to claim 2, wherein the plurality of air flow panels are shaped like an accordion.

4. The trash can vent according to claim 1, wherein the plurality of air flow panels include an air freshener affixed to one side of the plurality of air flow panels.

5. The trash can vent according to claim 1, wherein the plurality of cutouts are V-shaped.

6. The trash can vent according to claim 1, wherein the plurality of cutouts are U-shaped.

7. A method of venting a container comprising the steps of:
a. inserting a trash can vent into the container;
b. aligning the vent to surround the inner wall of the container;
c. creating a plurality of air panels along the length of the vent;
d. creating a plurality of cutouts at a bottom portion of the plurality of air flow panels;
e. supplying an attachment means on one side of the trash vent; and
f. attaching the vent to the inner wall of the container.
